(19) United States
(12) Patent Application Publication
(10) Pub. No.: US 2010/0199746 A1
(43) Pub. Date: Aug. 12, 2010

(54) Cantilever Type Sensor

(75) Inventors: Sumio Hosaka, Gunma (JP); Hayato Sone, Kiryu-shi (JP); Haruki Okano, Gunma (JP); Masami Iwasaki, Gunma (JP)

Correspondence Address: Hogan Lovells US LLP, 1999 AVENUE OF THE STARS, SUITE 1400, LOS ANGELES, CA, 90067, US

(73) Assignees: NATIONAL UNIVERSITY CORPORATION GUNMA UNIVERSITY, Maebashi-shi, Gunma (JP); TOKYO SOKKI KENKYUJO CO., LTD., Shinagawa-ku, Tokyo (JP)

(21) Appl. No.: 11/910,199

(22) PCT Filed: Mar. 30, 2006
(86) PCT No.: PCT/JP2006/306743

§ 371 Date: Sep. 28, 2007

(30) Foreign Application Priority Data
Mar. 31, 2005 (JP) 2005-105324

(51) Int. Cl. G01N 29/02; G01H 13/00; G01N 29/24

(52) U.S. Cl. 73/24.06; 73/579; 73/64.53

(57) ABSTRACT

A cantilever type sensor includes a cantilever, an actuator that oscillates the cantilever, and a sensor provided at the cantilever so as to detect an oscillation condition of the cantilever. Further, the cantilever type sensor includes a control unit that controls the actuator so as to cause the cantilever to be subjected to pulse excitation, and a measurement unit that measures a physical quantity related to a measurement object, based on a change in pulse response detected in the sensor.

### FIELD OF THE INVENTION

The present invention relates to a cantilever type sensor capable of measuring antigen-antibody reaction, protein or the like at high sensitivity, and particularly to a cantilever-type sensor capable of measuring a substance dissolved in a liquid or a substance suspended in the atmosphere at high sensitivity using a cantilever.

### BACKGROUND ART

A cantilever used in an atomic force microscope has a resonance point, and is used as a sensor capable of measuring a force in the unit of pN (piconewton), which is a minute force, by utilizing the resonance point being shifted by a force received from outside.

A cantilever utilized as a biosensor is described in a paper on sensors, published by Lang et al (“Artificial Nose” (Analytica Chamica Acta, Vol. 393 (1999), p. 59)).

This sensor detects a change in resonance frequency of a small cantilever utilizing an optical lever to detect a physical quantity, chemical quantity, temperature, stress or the like. This sensor requires an optical system in which a laser beam irradiated from a semiconductor laser is converged on a rear surface of the cantilever by utilizing a lens, and the laser beam reflected by the cantilever is caused to enter a position detector made of a photodiode and the like. Accordingly, in this biosensor, for example, in a case where after the optical axis adjustment of the optical system is performed in air, this biosensor is immersed into a liquid or the like to be used having a refractive index different from that of air, an optical path length thereof changes, which requires the optical axis readjustment, and thus, this sensor cannot be used easily.

Moreover, a sensor utilizing a self-detection type cantilever is proposed, and this sensor constantly produces resonance to detect a resonance frequency, and based on the resonance frequency, weight change of a substance adhering to the cantilever is measured.

### DISCLOSURE OF THE INVENTION

### Problem to be Solved by the Invention

However, the sensor utilizing the above-described self-detection cantilever measures only weight change of the substance adhering to the cantilever on the assumption that change in viscosity of the measurement object and the like are constant, but in a liquid or the like, the resonance frequency change due to the change in viscosity of the measurement object, and thus, there is a problem such that the weight change or change in another factor cannot be precisely measured only through detection of the resonance frequency.

The present invention is achieved in order to solve the above-described problem, and an object of the invention is to provide a cantilever type sensor capable of measuring a physical quantity of a measurement object easily.

### Means to Solve the Problem

According to one aspect of the present invention, a cantilever type sensor is provided which includes: a cantilever; an actuator that oscillates the cantilever; a sensor provided at the cantilever so as to detect an oscillation condition of the cantilever; a control unit that controls the actuator to so as to cause the cantilever to be subjected to pulse excitation; and a measurement unit that measures a physical quantity related to a measurement object, based on a change in pulse response detected in the sensor.

According to another aspect of the present invention, a cantilever type sensor is provided which includes: a cantilever; an actuator that oscillates the cantilever; a sensor provided at the cantilever so as to detect an oscillation condition of the cantilever; a control unit that controls the actuator so as to cause the cantilever to be subjected to pulse excitation; and a measurement unit that measures a physical quantity related to a measurement object, based on a change in pulse response detected in the sensor, wherein

the control unit causes the cantilever to be subjected to impulse excitation once or several times,

the measurement unit measures the physical quantity related to the measurement object, based on the respective change in the respective impulse response(s) detected in the sensor,

the pulse response detected in the sensor is at least one of a frequency of the oscillation in the pulse response, a delay time from a time when the pulse excitation is performed to a time when the cantilever is oscillated by the pulse response, a maximum amplitude of the oscillation in the pulse response, a change in an oscillation amplitude or attenuation coefficient in the pulse response, or a total transmitted energy in the pulse response,

the cantilever is covered with one or more layers of thin film, and is immersed in a liquid containing the measurement object or is placed in an atmosphere containing the measurement object,

the actuator is formed by a piezoelectric element, a capacitance element or an electromagnetic induction element, and

the sensor provided at the cantilever includes a strain resistance element whose resistance changes in accordance with the oscillation of the cantilever, a capacitance element whose capacitance changes in accordance with the oscillation of the cantilever, a piezoelectric element in which a voltage is generated in accordance with the oscillation of the cantilever, or an electromagnetic induction element in which a voltage is generated in accordance with the oscillation of the cantilever.

Other aspects, characteristics, and advantages of the invention will be apparent from the below description in relation to the appended drawings.

### EFFECT OF THE INVENTION

As described above, according to the cantilever type sensor of the present invention, the cantilever is subjected to pulse excitation to detect a change in pulse response by the sensor provided at the cantilever, which provides an effect such that the physical quantity of the measurement object can be measured with ease.

### BRIEF DESCRIPTION OF THE DRAWINGS

FIG. 1 is a schematic diagram showing a structure of a cantilever type sensor according to a first embodiment of the present invention.

FIG. 2 is an image diagram showing an input waveform resulting from impulse excitation and an output waveform resulting from oscillation in impulse response.

FIG. 3 shows graphs illustrating changes in impulse response when impulse excitation is performed at arbitrary time intervals.

FIG. 4 is a flowchart showing the contents of a measurement processing routine of a personal computer according to a first embodiment of the invention.

FIG. 5 is a schematic diagram showing another structural example of an actuator according to a first embodiment of the invention.

FIG. 6 is a schematic diagram showing another structural example of a cantilever according to a first embodiment of the invention.

FIG. 7 is a schematic diagram showing a structure of a cantilever type sensor according to a second embodiment of the invention.

FIG. 8 is a schematic diagram showing a structure of a cantilever type sensor according to a third embodiment of the invention.

FIG. 9 is a schematic diagram showing a structure of a cantilever type sensor according to a fourth embodiment of the invention.

FIG. 10 is a schematic diagram showing a structure of a cantilever type sensor according to a fifth embodiment of the invention.

### BEST MODE FOR CARRYING OUT THE INVENTION

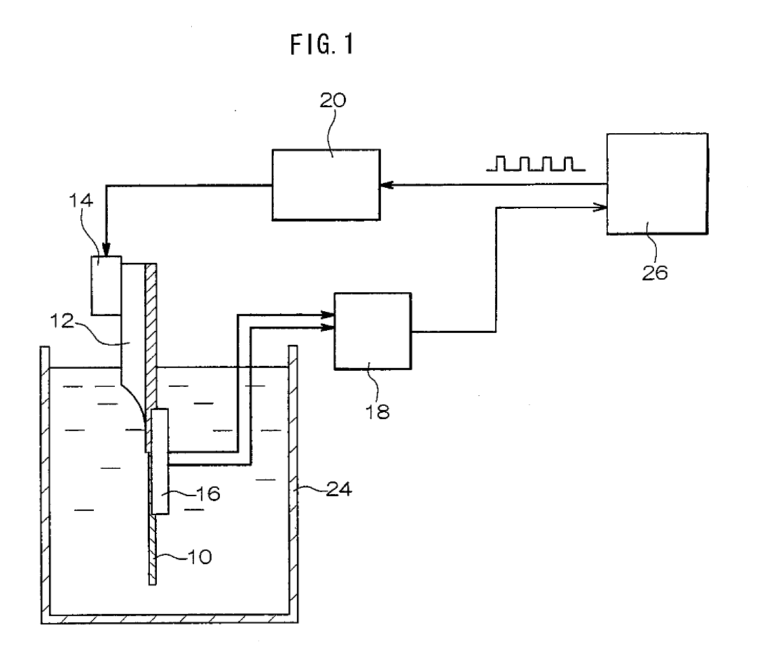

Hereinafter, referring to the drawings, embodiments of the present invention are described. As shown in FIG. 1, a cantilever type sensor according to a first embodiment of the invention includes a thin plate-like cantilever 10 formed contiguously with a base 12. The cantilever 10 may be formed in a V shape in which the base end portion thereof is divided into two portions and the tip end portions thereof are joined together. Alternatively, the cantilever 10 may be formed in a rectangular shape or in an elongate shape.

Attached to the base 12 is an actuator 14 formed by a piezoelectric element that causes the cantilever 10 to be oscillated by exciting the base 12. More specifically, the actuator 14 is adhesively or mechanically joined to the base 12 so as to be integral with the base 12. Further, the actuator 14 may be attached at any position where the cantilever 10 can be oscillated in a thickness direction of the cantilever 10. The actuator is attached to a portion of the base 12 where the cantilever is not formed, as shown in the Figure or to a portion of the base 12 where the cantilever is formed.

Moreover, a strain resistance element 16, which is a self-sensing type sensor, is embedded in a predetermined region including a border portion between the cantilever 10 and the base 12. By oscillating the cantilever 10 in the thickness direction by the actuator 14 causes tensile and compression stress in the border portion between the cantilever 10 and the base 12, a resistance value of the strain resistance element 16 is changed; thus, an oscillating condition of the cantilever 10 can be detected from the change in the resistance value.

The cantilever 10 can be formed integrally with the base 12 by etching a semiconductor substrate of silicon or the like into a thin plate in a manner such that a portion corresponding to the base 12 remains. Moreover, the strain resistance element 16 is fabricated in a manner such that a pair of electrodes is formed in the border portion of the cantilever 10 with the base 12 by a semiconductor technique and a strain resistor is formed by implanting ions of impurity atoms of boron or the like between the electrodes. The strain resistor desirably has a resistance value of 2 kΩ, or less. While the cantilever 10 and the base 12 are preferably formed of a silicon substrate, the electrodes may be formed without performing ion implantation and the strain resistance element 16 may be adhered to the electrodes.

A detection circuit 18 for detecting the change in the resistance value of the strain resistance element 16 is connected to the electrodes of the strain resistance element 16. The detection circuit 18 includes a bridge circuit forming a Wheatstone bridge to which the electrodes of the strain resistance element 16 are connected, and a power supply that applies voltage to the bridge circuit, and detects the resistance change of the strain resistance element 16 as voltage change to output a detected signal. Further, the detection circuit 18 is connected to a personal computer 26 that performs data processing and display.

The personal computer 26 has a configuration of a general personal computer, which includes CPU, ROM, RAM, hard disc, display and the like, stores data inputted from the detection circuit 18 in the hard disc, and performs predetermined data processing based on the stored data. Moreover, the personal computer 26 is connected to an excitation circuit 20, which will be described later, and performs control such that the excitation circuit 20 outputs an oscillation signal.

The excitation circuit 20 is connected to the actuator 14 and outputs the oscillation signal to the actuator 14 to thereby oscillate the actuator 14.

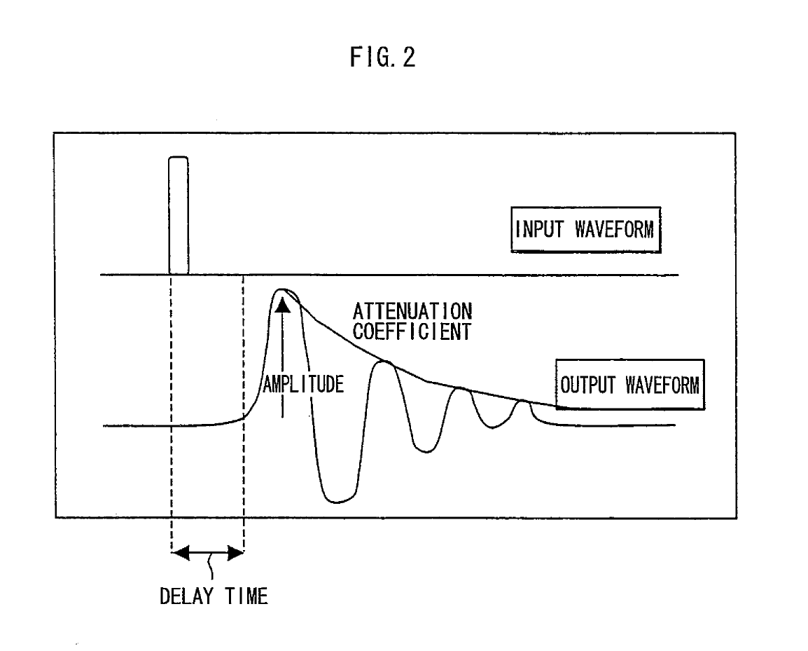

Next, a principle for measuring a physical quantity related to a measurement object in the embodiment is described. When the cantilever 10 is subjected to impulse excitation so that an input waveform as shown in FIG. 2 is supplied to the cantilever 10, an output waveform results from the oscillation in impulse response. In this output waveform, a delay time occurs from a time when the impulse excitation is performed to a time when the cantilever 10 starts the oscillation by the impulse response. Moreover, the first oscillation in the impulse response represents a maximum amplitude, and then the amplitude gradually decreases over time. This decrease in amplitude can be represented by an attenuation coefficient. This oscillation has a predetermined frequency, and a total transmitted energy from the actuator 14 is sought from the oscillation in the impulse response and energy dissipation is sought from the total transmitted energy.

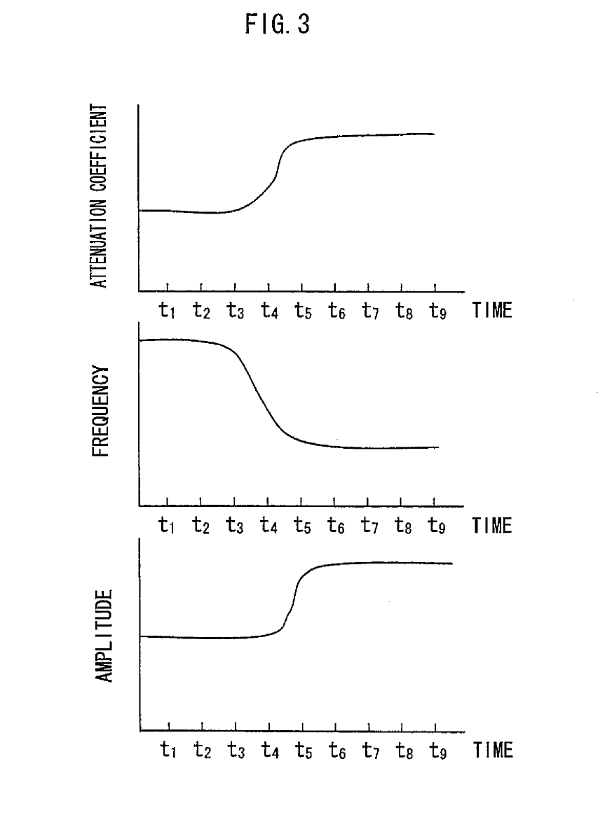

Moreover, when the measurement object changes physically or chemically, at least one of the above-described delay time, maximum amplitude, attenuation coefficient, frequency, and total transmitted energy changes in the output waveform resulting from the oscillation in the impulse response. In the case where the physical or chemical change of the measurement object progresses over time, the cantilever 10 is subjected to the impulse excitation at intervals of arbitrary time (in FIG. 3, at the timing of t1 to t9), so that the attenuation coefficient, frequency, and maximum amplitude change as shown in FIG. 3. For example, between t3 to t5, it is observed that the change of the measurement object occurs.

Examples of the physical quantity of the measurement object includes a viscosity of the measurement object, weight of a substance adhering to the cantilever 10, and spring constant when the cantilever 10 and the substance adhering to the cantilever 10 are regarded as one cantilever. The change in viscosity of the measurement object can be measured from the change in the attenuation coefficient, the change in the viscosity of the measurement object can be measured from the change in the maximum amplitude, and the change in the above-described spring constant can be measured from the change in the maximum amplitude. Moreover, the change in the weight of the substance adhering to the cantilever 10, the change in the viscosity of the measurement object, and the change in the above-described spring constant can be measured from the change in the frequency. By integrating the changes of these physical quantities, the physical quantity on the measurement object can be measured.

In the embodiment, as the number of molecules and the like of the adhering substance to the cantilever 10 increases and thus the weight of the adhering substance increases, the frequency gradually decreases. Moreover, as the viscosity increases, the attenuation coefficient increases and the maximum amplitude decreases.

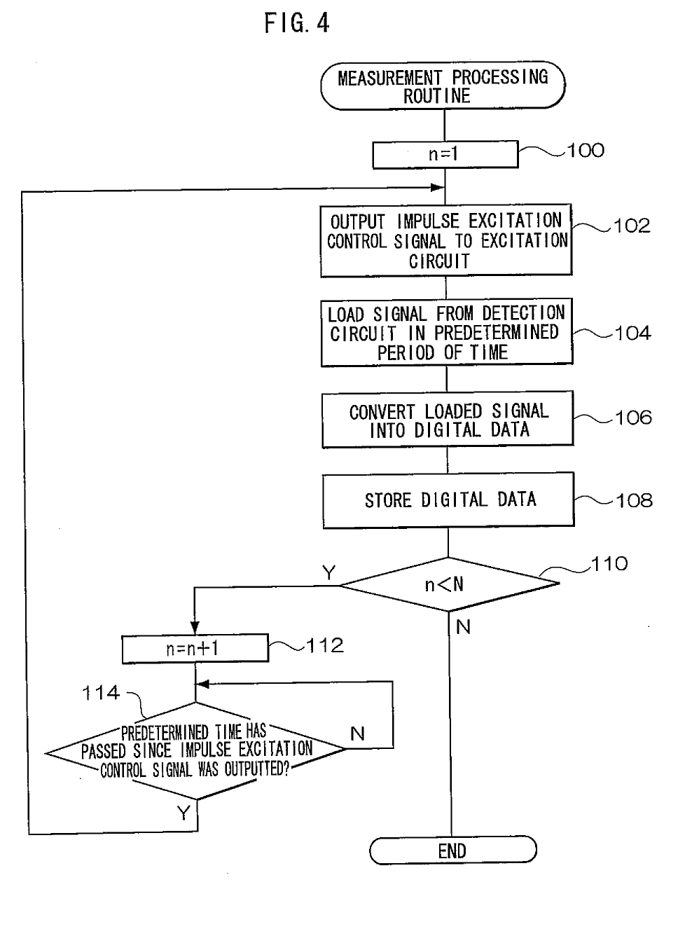

Hereinafter, a measurement method using the cantilever type sensor of the embodiment is described. The personal computer 26 executes a measurement processing routine shown in FIG. 4, in which at step 100, a value n indicating the number of measurements is set to 1 as an initial value, and at step 102, an impulse excitation control signal for causing the actuator 14 to be subjected to impulse excitation is outputted to the excitation circuit 20, so that an excitation signal for causing the actuator 14 to be subjected to the impulse excitation is inputted to the actuator 14 from the excitation circuit 20. Consequently, the base 12 is subjected to the impulse excitation, so that the cantilever 10 is subjected to the impulse excitation in the thickness direction of the cantilever 10. When the cantilever 10 is immersed in a reaction solution in a container 24, the reaction solution adheres to the cantilever 10 as time elapses, and the impulse response of the cantilever 10 changes under the influence of the viscosity of the reaction solution. Since the movements of the cantilever 10 and the base 12 at this time are not integral to each other, tensile or compression stress occurs in the strain resistance element 16, and the resistance of the strain resistance element 16 changes, so that with a constant voltage to being applied to the strain resistance element 16, the current changes in accordance with the oscillation of the cantilever 10. By detecting this current change as a voltage change in the bridge circuit of the detection circuit 18, the change in oscillation of the cantilever 10 in the impulse response can be detected.

At step 104, a signal indicating the voltage change detected in the detection circuit 18 is taken in for a predetermined period of time, and at step 106, the signal taken in from the detection circuit 18 is converted to digital data. At step 108, the converted digital data is stored in the hard disc.

At step 110, it is determined whether or not n is smaller than a numeric value N indicating the number of measurements to be performed in the measurement processing. If n is smaller than N, then at step 112, the value of n is incremented, and at step 114, it is determined whether or not a predetermined time has elapsed since the time when the impulse excitation control signal was outputted at step 102, and if the predetermined time has elapsed, the process returns from step 114 to step 102.

After the process from step 102 to step 108 is repeated N times, the determination at step 110 is negated, and the measurement processing routine is finished.

Between steps 102 and 108, the waveform as shown in FIG. 2 is generated and stored, based on the digital data stored in the hard disc, and the waveform is displayed on the display. Moreover, from the stored waveform, at least one of the delay time, maximum amplitude, frequency, attenuation coefficient, and transmitted energy is calculated, and the calculated value is stored in the hard disc. Based on at least one value of the stored delay time, maximum amplitude, frequency, attenuation coefficient, and transmitted energy, a time-dependent change in this value is detected, and from the time-dependent change of the value, the change in physical quantity related to the measurement object is measured. Moreover, by integrating the changes in physical quantity measured for the predetermined period of time, the physical quantity related to the measurement object is calculated. Alternatively, two or more values of the delay time, maximum amplitude, frequency, attenuation coefficient and transmitted energy may be combined to measure the change in physical quantity related to the measurement object.

The change in physical quantity related to the measurement object measured in this manner, and the calculated physical quantity are shown on the display. The personal computer 26 may carry out noise removal, and process and calculate reaction rate, and the like.

In order to utilize the cantilever type sensor of the embodiment for detecting an antigen-antibody reaction, an antibody is first caused to adhere to a surface of the cantilever 10, and the cantilever 10 is immersed in a reaction solution. Then, a measurement sample having an antigen is put into the reaction solution in the reaction container 24. Alternatively, the cantilever 10 is immersed into a solution, the antibody in a stable state is put into the solution, and after the reaction becomes stable, antigen is additionally put in. This makes it clear whether the measurement sample has a constitutional factor such as allergy or the like. By changing the order of putting the antibody and the antigen, it can be observed that an allergy substance is generated in a human body.

As described above, with the cantilever type sensor according to the first embodiment of the invention, the cantilever is subjected to the impulse excitation several times to detect at least one of the delay time, maximum amplitude, frequency, attenuation coefficient and transmitted energy in each impulse response by the strain resistance element provided in the cantilever, and to detect at least one of the changes of the delay time, maximum amplitude, frequency, attenuation coefficient, and transmitted energy. Thereby, the physical quantity related to the measurement object can be measured easily.

Further, since the strain resistance element is embedded as a sensor in the cantilever and hence no optical lever method is used, no optical axis readjustment is required when the cantilever type sensor is used in a solution or the like, so that the cantilever type sensor can be used easily and conveniently.

Further, since the signal indicating the voltage change detected in the detection circuit is converted into digital data, and the physical quantity related to the measurement object is measured based on this digital data, no limitation is laid on the detectable frequency domain in the voltage change, and even large voltage change can be detected with high accuracy. Consequently, the physical quantity related to the measurement object can be measured with high accuracy and over a wide range.

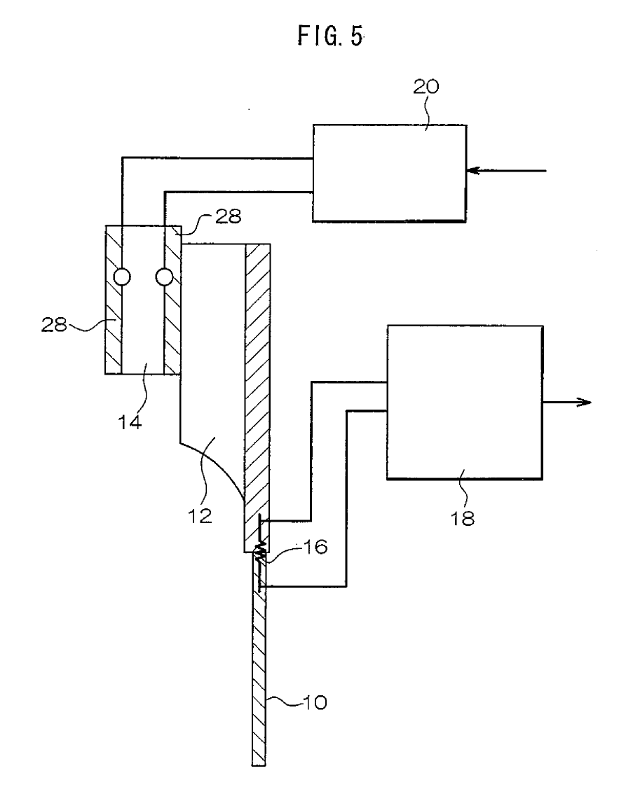

In the embodiment, while description has been made of the case where the actuator 14 is formed by a piezoelectric element, it is possible that in the embodiment, as shown in FIG. 5, insulating films 28 may cover to electrically insulate the respective electrode portions of the piezoelectric element in the embodiment as shown in FIG. 5. In this case, too, as described above, one of the insulating films of the actuator 14 is adhesively or mechanically joined to the base 12 so as to make the actuator 14 integral with the base 12. Since the electrodes of the actuator 14 are covered with the insulating films 28, when this cantilever 10 is immersed in a reaction solution, leak current decreases so that accurate measurement can be achieved

Moreover, while in the foregoing, the case where the cantilever is immersed in the solution is described, the cantilever may be located in an atmosphere where the measurement object is suspended.

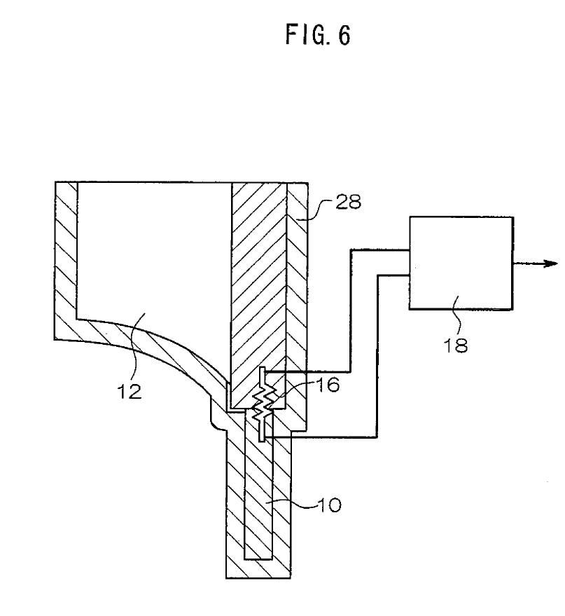

Moreover, as shown in FIG. 6, the cantilever 10 and the base 12 may be covered with the insulating film 28. In this case, the actuator 14 may be covered or may not be covered with the insulating film as shown in FIG. 5. This prevents leak current from flowing in the surface of the cantilever 10 when the cantilever 10 is immersed in the reaction solution, which enables the detection circuit 18 to accurately measure the current.

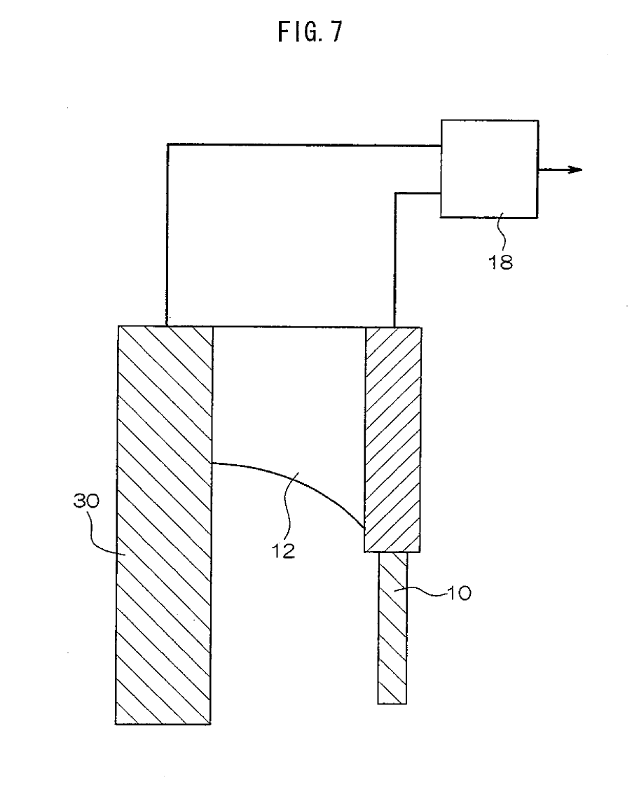

Next, a second embodiment of the invention is described, wherein as the sensor detecting the change of an oscillation condition in impulse response, a capacitance element whose capacitance changes in response to the oscillation of the cantilever is used in place of the strain resistance element of the first embodiment. In the embodiment, as shown in FIG. 7, a counter electrode 30 is fixed to the base 12 so as to be opposed to, and parallel to the cantilever 10 so that a capacitance element is formed between the counter electrode 30 and the cantilever 10. Further, the cantilever 10 and the counter electrode 30 are connected to the detection circuit 18 including a bridge circuit making up a Wheatstone bride together with the capacitance element as in the foregoing. Thus, the capacitance of the capacitance element is periodically changed due to oscillation of the cantilever, so that the oscillation of the cantilever may be detected by the bridge circuit of the detection circuit and an oscillatory signal may be outputted.

According to the present embodiment, a change in the impulse response is detected from the oscillatory signal outputted from the detection circuit, and the time-dependent change of the physical quantity related to the measurement object, or the like can be detected from this change in the impulse response, as in the foregoing case.

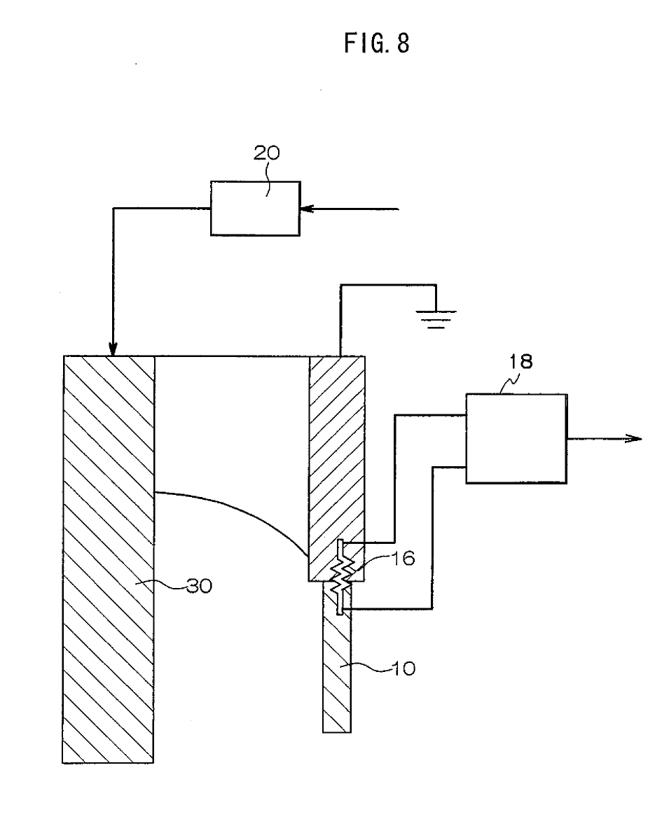

Next, referring to FIG. 8, a third embodiment of the invention is described. In the embodiment, the counter electrode of the second embodiment is used as an actuator. As a sensor detecting the oscillation of the cantilever, a strain resistance element is used as in the first embodiment.

The strain resistance element 16 is connected to a bridge circuit of the detection circuit 18 as in the first embodiment. Moreover, the base end side of the cantilever 10 is grounded, and the counter electrode 30 making up a capacitance element is connected to the excitation circuit 20.

According to the embodiment, the excitation control signal is inputted to the excitation circuit 20 from the personal computer 26, and the excitation signal is inputted to the counter electrode 30, so that the cantilever 10 is controlled by the personal computer 26 so as to be subjected to impulse excitation. The voltage change of the strain resistance element 16 is detected in the bridge circuit of the detection circuit 18, the detected signal is inputted to the personal computer 26, and in the personal computer 26, as in the foregoing, the time-dependent change of the physical quantity related to the measurement object is detected from the change in the impulse response.

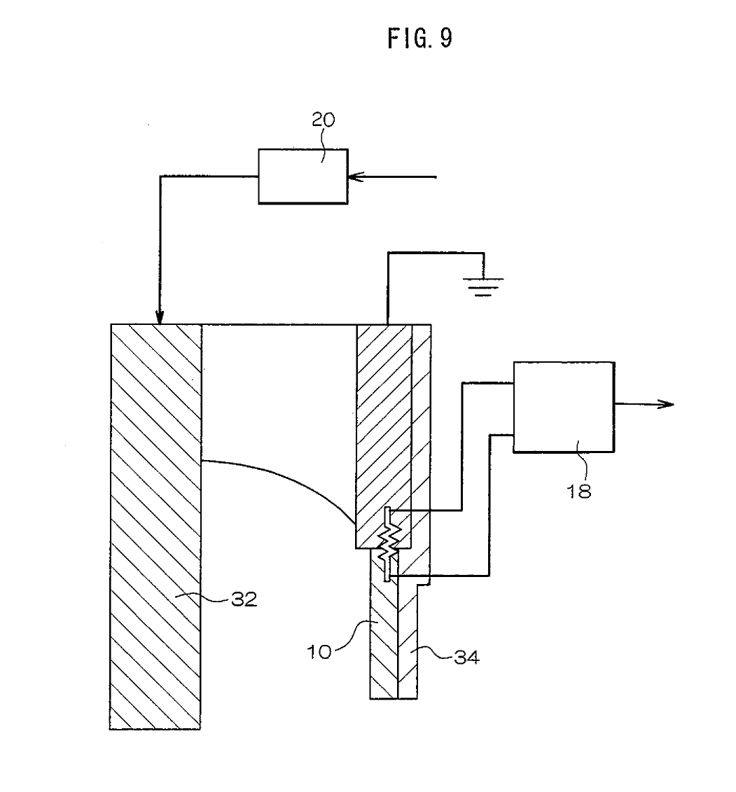

Next, referring to FIG. 9, a fourth embodiment of the invention is described, wherein an electromagnetic induction type actuator is used in place of the electrostatic actuator of the third embodiment. In the embodiment, an electromagnetic induction coil 32 is fixed to the base 12 so as to be opposed to, and substantially parallel to the cantilever 10, and a magnetic thin film 34 of a magnetic material is coated on the front surface side of the cantilever 10. As a sensor detecting the oscillation of the cantilever, a strain resistance element similar to that of the first embodiment is used.

According to the embodiment, the excitation control signal is inputted to the excitation circuit 20 from the personal computer 26, and the excitation signal is inputted to the electromagnetic induction coil 32, so that the cantilever 10 is subjected to the impulse excitation. Moreover, as in the foregoing, the signal from the strain resistance element 16 is detected in the bridge circuit of the detection circuit 18, the signal detected in the bridge circuit of the detection circuit 18 is inputted to the personal computer 26, and in the personal computer 26, the time-dependent change of the physical quantity on the measurement object or the like is detected from the change in the impulse response. While in FIG. 9, only one surface of the cantilever is coated, the both surfaces may be coated, or the surface opposite to that in FIG. 9 may be coated.

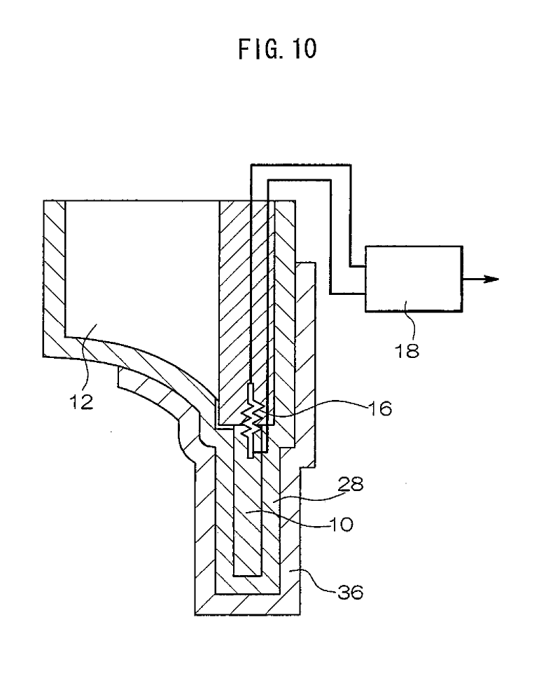

FIG. 10 shows a fifth embodiment of the invention, in which in order to cause a substance to be detected to adhere, the insulating film of the cantilever shown in FIG. 6 is covered with a thin film 36 made of gold or the like for causing a special chemical reaction group to adhere thereto. The type of the thin film is selected in accordance with the adhering substance as necessary. Thus, the time-dependent change in physical quantity related to the measurement object such as protein, DNA, antibody, antigen, which are selected artificially in the presence of a thiol group or the like, can be detected.

While in the foregoing embodiments, the case where the strain resistance element or the capacitance element is used as the self-sensing element is described, a piezoelectric element, electromagnetic induction element, temperature sensing element or the like may be used. Moreover, as the actuator, a thermally-driven actuator, optically-driven actuator or the like may be used in place of the piezoelectric element and the electrostatic capacitance element. Furthermore, while the case where the cantilever is covered with the insulating film is described, it may be covered with a natural oxidation film.

Moreover, while in the foregoing, the case where one cantilever is used is described, a plurality of cantilevers may be provided on the base to measure the physical quantity related to the measurement object at the respective cantilevers.

As understood from the above description, according to the cantilever type sensor according to the invention, the control unit controls the actuator so that the cantilever is subjected to pulse excitation, and the measurement unit measures the physical quantity on the measurement object based on the change in the pulse response detected in the sensor.

Accordingly, by causing the cantilever to be subjected to pulse excitation to detect the change in the pulse response by the sensor provided in the cantilever, it is possible to easily measure the physical quantity related to the measurement object.

Moreover, the control unit according to the invention can cause the cantilever to be subjected to impulse excitation. Furthermore, the control unit causes the cantilever to be subjected to impulse excitation several times, and the measurement unit can measure the physical quantity related to the measurement object based on the respective changes in the impulse response detected in the sensor. Thus, the cantilever is impulse-excited several times to detect the respective changes in the impulse response by the sensor provided in the cantilever, which allows the physical quantity related to the measurement object to be measured with ease.

The pulse response detected in the sensor according to the invention may be at least one of the frequency of the oscillation in the pulse response, delay time from the time when the pulse excitation is caused to the time when the cantilever is oscillated based on the pulse response, maximum amplitude of the oscillation in the pulse response, change in the oscillation amplitude or attenuation coefficient in the pulse response, and total transmitted energy in the pulse response.

Moreover, the cantilever can be immersed in a liquid containing the measurement object, or can be arranged in an atmosphere containing the measurement object.

Moreover, the cantilever according to the invention can be covered with one or more layers of thin film. The covering with one or more layer of thin film can prevent current leak when the cantilever type sensor is used in a liquid or the like.

The actuator according to the invention may be made of a piezoelectric element, capacitance element, or electromagnetic induction element.

Moreover, the sensor provided in the cantilever according to the invention may include a strain resistance element whose resistance changes in accordance with the oscillation of the cantilever, a capacitance element whose capacitance changes in accordance with the oscillation of the cantilever, a piezoelectric element in which a voltage is generated in accordance with the oscillation of the cantilever, or an electromagnetic induction element in which a voltage is generated in accordance with the oscillation of the cantilever. This makes unnecessary a readjustment when using the cantilever type sensor, thus allowing the cantilever type sensor to be used easily and conveniently.

While the specific embodiments of the invention have been described in detail in the foregoing, the invention is not limited to these embodiments, but it should be understood that any and all possible modifications and variations within the scope and spirit of the invention are encompassed.

All the disclosure of Japanese Patent Application No. 2005-105324 is incorporated herein by reference.

### EXPLANATION OF THE REFERENCE NUMERALS

10 Cantilever
12 Base
14 Actuator
16 Resistance element
18 Detection circuit
20 Excitation circuit
26 Personal computer
28 Insulating film
30 Counter electrode
32 Electromagnetic induction coil
34 Magnetic thin film
36 Thin film

1. A cantilever type sensor comprising:
a cantilever;
an actuator that oscillates the cantilever;
a sensor provided at the cantilever so as to detect an oscillation condition of the cantilever;
a control unit that controls the actuator to so as to cause the cantilever to be subjected to pulse excitation; and
a measurement unit that measures a physical quantity related to a measurement object, based on a change in pulse response detected in the sensor.

2. The cantilever type sensor of claim 1, wherein the control unit causes the cantilever to be subjected to impulse excitation.

3. (canceled)

4. The cantilever type sensor of claim 2, wherein the control unit causes the cantilever to be subjected to impulse excitation several times, and
the measurement unit measures a physical quantity related to the measurement object, based on a change in the respective impulse responses detected by the sensor.

5. The cantilever type sensor of claim 1, wherein the pulse response detected by the sensor is at least one of a frequency of the oscillation in the pulse response, a delay time from a time when the pulse excitation is performed to a time when the cantilever is oscillated by the pulse response, a maximum amplitude of the oscillation in the pulse response, a change in an oscillation amplitude or attenuation coefficient in the pulse response, or a total transmitted energy in the pulse response.

6. The cantilever type sensor of claim 2, wherein the pulse response detected by the sensor is at least one of a frequency of the oscillation in the pulse response, a delay time from a time when the pulse excitation is performed to a time when the cantilever is oscillated by the pulse response, a maximum amplitude of the oscillation in the pulse response, a change in an oscillation amplitude or attenuation coefficient in the pulse response, or a total transmitted energy in the pulse response.

7. The cantilever type sensor of claim 1, wherein the pulse response detected by the sensor is at least one of a frequency of the oscillation in the pulse response, a delay time from a time when the pulse excitation is performed to a time when the cantilever is oscillated by the pulse response, a maximum amplitude of the oscillation in the pulse response, a change in an oscillation amplitude or attenuation coefficient in the pulse response, or a total transmitted energy in the pulse response.

8. The cantilever type sensor of claim 1, wherein the cantilever is immersed in a liquid containing the measurement object, or is placed in an atmosphere containing the measurement object.

9. The cantilever type sensor of claim 2, wherein the cantilever is immersed in a liquid containing the measurement object, or is placed in an atmosphere containing the measurement object.

10. The cantilever type sensor of claim 1, wherein the cantilever is immersed in a liquid containing the measurement object, or is placed in an atmosphere containing the measurement object.

11. The cantilever type sensor of claim 5, wherein the cantilever is immersed in a liquid containing the measurement object, or is placed in an atmosphere containing the measurement object.

12. The cantilever type sensor of claim 1, wherein the cantilever is covered with one or more layers of thin film.

13. (canceled)

14. (canceled)

15. (canceled)

16. (canceled)

17. The cantilever type sensor of claim 1, wherein the actuator is formed by a piezoelectric element, a capacitance element or an electromagnetic induction element.

18. The cantilever type sensor of claim 2, wherein the actuator is formed by a piezoelectric element, a capacitance element or an electromagnetic induction element.

19. The cantilever type sensor of claim a 1, wherein the actuator is formed by a piezoelectric element, a capacitance element or an electromagnetic induction element.

20. The cantilever type sensor of claim 5, wherein the actuator is formed by a piezoelectric element, a capacitance element or an electromagnetic induction element.

21. The cantilever type sensor of claim 8, wherein the actuator is formed by a piezoelectric element, a capacitance element or an electromagnetic induction element.

22. The cantilever type sensor of claim 12, wherein the actuator is formed by a piezoelectric element, a capacitance element or an electromagnetic induction element.

23. The cantilever type sensor of claim 1, wherein the sensor provided at the cantilever includes a strain resistance element whose resistance changes in accordance with the oscillation of the cantilever, a capacitance element whose capacitance changes in accordance with the oscillation of the cantilever, a piezoelectric element in which a voltage is generated in accordance with the oscillation of the cantilever, or an electromagnetic induction element in which a voltage is generated in accordance with the oscillation of the cantilever.

24. The cantilever type sensor of claim 2, wherein the sensor provided at the cantilever includes a strain resistance element whose resistance changes in accordance with the oscillation of the cantilever, a capacitance element whose capacitance changes in accordance with the oscillation of the cantilever, a piezoelectric element in which a voltage is generated in accordance with the oscillation of the cantilever, or an electromagnetic induction element in which a voltage is generated in accordance with the oscillation of the cantilever.

25. The cantilever type sensor of claim 1, wherein the sensor provided at the cantilever includes a strain resistance element whose resistance changes in accordance with the oscillation of the cantilever, a capacitance element whose capacitance changes in accordance with the oscillation of the cantilever, a piezoelectric element in which a voltage is generated in accordance with the oscillation of the cantilever, or an electromagnetic induction element in which a voltage is generated in accordance with the oscillation of the cantilever.

26. The cantilever type sensor of claim 5, wherein the sensor provided at the cantilever includes a strain resistance element whose resistance changes in accordance with the oscillation of the cantilever, a capacitance element whose capacitance changes in accordance with the oscillation of the cantilever, a piezoelectric element in which a voltage is generated in accordance with the oscillation of the cantilever, or an electromagnetic induction element in which a voltage is generated in accordance with the oscillation of the cantilever.

27. The cantilever type sensor of claim 8, wherein the sensor provided at the cantilever includes a strain resistance element whose resistance changes in accordance with the oscillation of the cantilever, a capacitance element whose capacitance changes in accordance with the oscillation of the cantilever, a piezoelectric element in which a voltage is generated in accordance with the oscillation of the cantilever, or an electromagnetic induction element in which a voltage is generated in accordance with the oscillation of the cantilever.

28. The cantilever type sensor of claim 12, wherein the sensor provided at the cantilever includes a strain resistance element whose resistance changes in accordance with the oscillation of the cantilever, a capacitance element whose capacitance changes in accordance with the oscillation of the cantilever, a piezoelectric element in which a voltage is generated in accordance with the oscillation of the cantilever, or an electromagnetic induction element in which a voltage is generated in accordance with the oscillation of the cantilever.

29. The cantilever type sensor of claim 17, wherein the sensor provided at the cantilever includes a strain resistance element whose resistance changes in accordance with the oscillation of the cantilever, a capacitance element whose capacitance changes in accordance with the oscillation of the cantilever, a piezoelectric element in which a voltage is generated in accordance with the oscillation of the cantilever, or an electromagnetic induction element in which a voltage is generated in accordance with the oscillation of the cantilever.

30. A cantilever type sensor comprising:
a cantilever;
an actuator that oscillates the cantilever;
a sensor provided at the cantilever so as to detect an oscillation condition of the cantilever;
a control unit that controls the actuator so as to cause the cantilever to be subjected to pulse excitation; and
a measurement unit that measures a physical quantity related to a measurement object, based on a change in pulse response detected in the sensor, wherein
the control unit causes the cantilever to be subjected to impulse excitation once or several times,
the measurement unit measures the physical quantity related to the measurement object, based on the respective change in the respective impulse response(s) detected in the sensor,
the pulse response detected in the sensor is at least one of a frequency of the oscillation in the pulse response, a delay time from a time when the pulse excitation is performed to a time when the cantilever is oscillated by the pulse response, a maximum amplitude of the oscillation in the pulse response, a change in an oscillation amplitude or attenuation coefficient in the pulse response, or a total transmitted energy in the pulse response,
the cantilever is covered with one or more layers of thin film, and is immersed in a liquid containing the measurement object or is placed in an atmosphere containing the measurement object,
the actuator is formed by a piezoelectric element, a capacitance element or an electromagnetic induction element, and
the sensor provided at the cantilever includes a strain resistance element whose resistance changes in accordance with the oscillation of the cantilever, a capacitance element whose capacitance changes in accordance with the oscillation of the cantilever, a piezoelectric element in which a voltage is generated in accordance with the oscillation of the cantilever, or an electromagnetic induction element in which a voltage is generated in accordance with the oscillation of the cantilever.
